(19) United States
(12) Patent Application Publication
(10) Pub. No.: US 2016/0337416 A1
(43) Pub. Date: Nov. 17, 2016

(54) System and Method for Digital Ink Input

(71) Applicant: SMART Technologies ULC, Calgary (CA)

(72) Inventors: Davin GALBRAITH, Calgary (CA); Roberto SIROTICH, Calgary (CA); Michael BOYLE, Calgary, CA (US)

(21) Appl. No.: 14/721,899

(22) Filed: May 26, 2015

Related U.S. Application Data
(63) Continuation-in-part of application No. 14/712,452, filed on May 14, 2015.

(51) Int. Cl. H04L 29/06; G06F 3/0484

(52) U.S. Cl. CPC H04L 65/403; G06F 3/04847

(57) ABSTRACT

The invention relates generally to improving content input between interactive input systems in a collaborative session. A mobile device having a processing structure; a transceiver communicating with a network using a communication protocol; and a computer-readable medium having instructions configures the processing structure to: receive a content object from an interactive device; perform recognition on the content object; determine a command code from the recognized content object; and modify another content object based at least in part on the command code.

This application is a continuation-in-part of U.S. patent application Ser. No. 14/712,452, filed May 15, 2015, hereby incorporated by reference.

### FIELD OF THE INVENTION

The present invention relates generally to improving content input of an interactive input system. More particularly, the present invention relates to a method and system of improving content input between interactive input systems in a collaborative session.

### BACKGROUND OF THE INVENTION

With the increased popularity of distributed computing environments and smart phones, it is becoming increasingly unnecessary to carry multiple devices. A single device can provide access to all of a user's information, content, and software. Software platforms can now be provided as a service remotely through the Internet. User data and profiles are now stored in the “cloud” using services such as Facebook®, Google Cloud storage, Dropbox®, Microsoft OneDrive®, or other services known in the art. One problem encountered with smart phone technology is that users frequently do not want to work primarily on their smart phone due to their relatively small screen size and/or user interface.

Conferencing systems that allow participants to collaborate from different locations, such as for example, SMART Bridgit™, Microsoft® Live Meeting, Microsoft® Lync, Skype™, Cisco® MeetingPlace, Cisco® WebEx, etc., are well known. These conferencing systems allow meeting participants to exchange voice, audio, video, computer display screen images and/or files. Some conferencing systems also provide tools to allow participants to collaborate on the same topic by sharing content, such as for example, display screen images or files amongst participants. In some cases, annotation tools are provided that allow participants to modify shared display screen images and then distribute the modified display screen images to other participants.

Prior methods for connecting smart phones, with somewhat limited user interfaces, to conferencing systems or more suitable interactive input devices such as interactive whiteboards, displays such as high-definition televisions (HDTVs), projectors, conventional keyboards, etc. have been unable to provide a seamless experience for users.

For example, SMART Bridgit™ offered by SMART Technologies ULC of Calgary, Alberta, Canada, assignee of the subject application, allows a user to set up a conference having an assigned conference name and password at a server. Conference participants at different locations may join the conference by providing the correct conference name and password to the server. During the conference, voice and video connections are established between participants via the server. A participant may share one or more computer display screen images so that the display screen images are distributed to all participants. Pen tools and an eraser tool can be used to annotate on shared display screen images, e.g., inject ink annotation onto shared display screen images or erase one or more segments of ink from shared display screen images. The annotations made on the shared display screen images are then distributed to all participants.

U.S. Publication No. 2012/0144283 to SMART Technologies ULC, assignee of the subject application, the entire disclosure of which is incorporated by reference, discloses a conferencing system having a plurality of computing devices communicating over a network during a conference session. The computing devices are configured to share content displayed with other computing devices. Each computing device in the conference session supports two input modes namely, an annotation mode and a cursor mode depending on the status of the input devices connected thereto. When a computing device is in the annotation mode, the annotation engine overlies the display screen image with a transparent annotation layer to annotate digital ink over the display. When cursor mode is activated, an input device may be used to select digital objects or control the execution of application programs.

U.S. Pat. No. 8,862,731 to SMART Technologies ULC, assignee of the subject application, the entire disclosure of which is incorporated by reference, presents an apparatus for coordinating data sharing in a computer network. Participant devices connect using a unique temporary session connect code to establish bidirectional communication session for sharing data on a designated physical display device. Touch data received from the display is then transmitted to all of the session participant devices. Once the session is terminated, a new unique temporary session code is generated.

U.S. Publication No. 2011/0087973 to SMART Technologies ULC, assignee of the subject application, the entire disclosure of which is incorporated by reference, discloses a meeting appliance running a thin client rich internet application configured to communicate with a meeting cloud, and access online files, documents, and collaborations within the meeting cloud. When a user signs into the meeting appliance using network credentials or a sensor agent such as a radio frequency identification (RFID) agent, an adaptive agent adapts the state of an interactive whiteboard to correspond to the detected user. The adaptive agent queries a semantic collaboration server to determine the user's position or department within the organization and then serves applications suitable for the user's position. The user, given suitable permissions, can override the assigned applications associated with the user's profile.

The invention described herein provides at least a system and method for digital content object input.

### SUMMARY OF THE INVENTION

According to one aspect of the invention, there is provided a mobile device having a processing structure, a transceiver communicating with a network using a communication protocol and a computer-readable medium having instructions to configure the processing structure. The processing structure receives a content object from an interactive device and performs recognition on the content object. A command code may be determined from the recognized content object and may modify another content object based in part on the command code. The processing structure may also receive at least one command code parameter; and modify the another content object based in part on the at least one command code parameter and may add the command code to a content object modifier list. The processing structure may modify at least a portion of a plurality of content objects based on the content object modifier list.

In response to the command code, the processing structure may adjust at least one content object attribute such as colour, or may manipulate the content object by way of scaling, rotation, and/or translation. The content object to be manipulated may be selected following the command code using a relative gesture to specify a manipulation quantity. The content object may be selected by one or more of the following: circling, tapping, underlining, and connecting to the command code.

According to another aspect of the invention, there is provided a mobile device having instructions to configure the processing structure to identify erasure of the content object associated with the command code; and remove the erased command code from the content object modifier list.

The command code may also cause the processing structure to adjust a canvas size or initialize a recognition engine in response to the command code. The recognition engine may be one or more of a shape recognition engine, a concept mapping engine, a chemical structure recognition engine, and/or a handwriting recognition engine.

The command code parameter may be a uniform resource locator to a remote content object.

In yet another aspect of the invention, there is provided a computer-implemented method comprising: receiving, at a mobile device, a content object from an interactive device over a communication channel; performing recognition on the content object; determining a command code from the recognized content object; and modifying another content object based in part on the command code. The method may also receive at least one command code parameter from the interactive device; and modify the another content object based in part on the at least one command code parameter. The method may also add the command code to a content object modifier list whereby the method may modify at least a portion of a plurality of content objects based on the command codes on the content object modifier list. The method may adjust at least one content object attribute such as colour based in part on the command code. The method may also involve manipulating the content object such as by scaling, rotation, and/or translation. The content object may be selected following the manipulation command code and the manipulation quantity may be adjusted by way of a gesture such as circling, tapping, underlining, and connecting to the command code.

In another aspect of the invention, the method may adjust a canvas size or initialize a custom recognition engine in response to the command code. The custom recognition engine may be selected from one or more of a shape recognition engine, a concept mapping engine, a chemical structure recognition engine, and/or a handwriting recognition engine.

The command code parameter may also comprise a uniform resource locator to a remote content object.

In another aspect of the invention, the computer-implemented method may identify erasure of the command code; and removing the erased command code from the content object modifier list.

In yet another aspect of the invention, there is provided an interactive device having a processing structure; an interactive surface; a transceiver communicating with a network using a communication protocol; and a computer-readable medium comprising instructions to configure the processing structure to: provide a command code to a mobile device; and provide command code parameters to the mobile device.

The interactive device in any of the aspects may be one or more of a capture board, an interactive whiteboard, an interactive flat screen display, or an interactive table.

### BRIEF DESCRIPTION OF THE DRAWINGS

An embodiment will now be described, by way of example only, with reference to the attached Figures, wherein:

FIG. 1 shows an overview of collaborative devices in communication with one or more portable devices and servers;

FIGS. 2A and 2B show a perspective view of a capture board and control icons respectively;

FIGS. 3A to 3C demonstrate a processing architecture of the capture board;

FIG. 4A to 4D show a touch detection system of the capture board;

FIG. 5 demonstrates a processing structure of a mobile device;

FIG. 6 shows a processing structure of one of more servers;

FIGS. 7A and 7B demonstrate an overview of processing structure and protocol stack of a communication system;

FIG. 8 demonstrates a protocol upgrade process for initiating a command interpreter;

FIG. 9 shows a flowchart of a mobile device configured to execute a content interpreter for interpreting and modifying a content object;

FIG. 10 shows a flowchart of a mobile device configured to remove content object modifiers; and

FIG. 11 shows an example of a content object modified by a command code.

### DETAILED DESCRIPTION OF THE EMBODIMENT

While the Background of Invention described above has identified particular problems known in the art, the present invention provides, in part, a new and useful application for input of digital content objects in a collaborative system with at least a portion of the participant devices having different input capabilities.

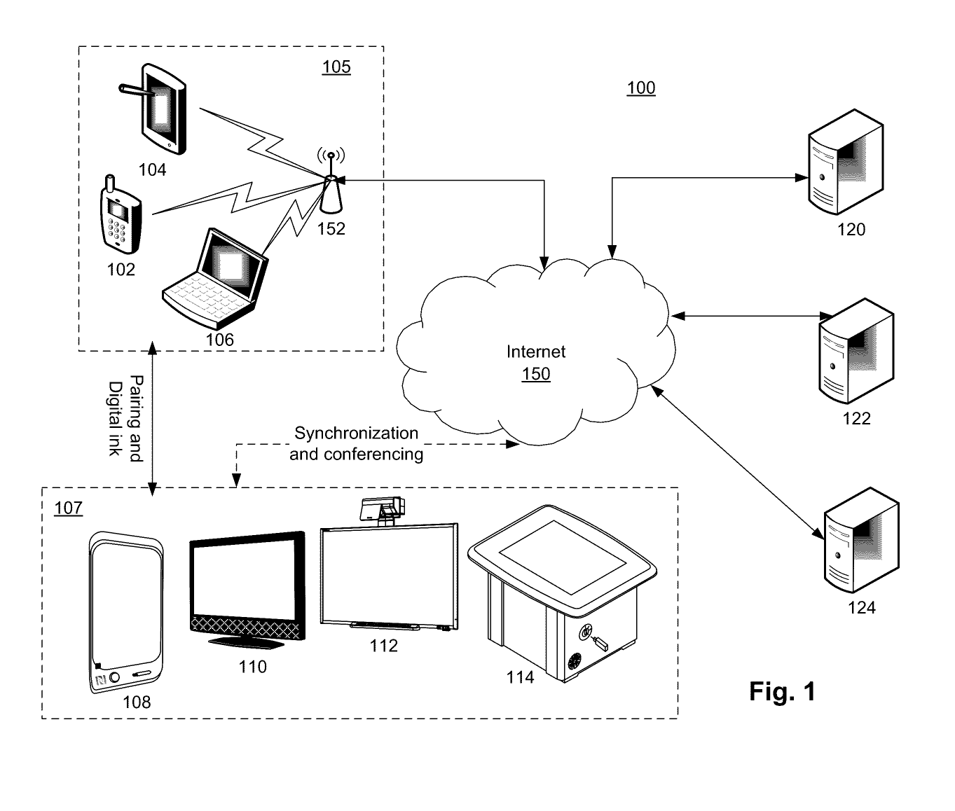

FIG. 1 demonstrates a high-level hardware architecture 100 of the present embodiment. A user has a mobile device 105 such as a smartphone 102, a tablet computer 104, or laptop 106 that is in communication with a wireless access point 152 such as 3G, LTE, WiFi, Bluetooth®, near-field communication (NFC) or other proprietary or non-proprietary wireless communication channels known in the art. The wireless access point 152 allows the mobile devices 105 to communicate with other computing devices over the Internet 150. In addition to the mobile devices 105, a plurality of collaborative devices 107 such as a Kapp™ capture board 108 produced by SMART Technologies, wherein the User's Guide is herein incorporated by reference, an interactive flat screen display 110, an interactive whiteboard 112, or an interactive table 114 may also connected to the Internet 150. The system comprises an authentication server 120, a profile or session server 122, and a content server 124. The authentication server 120 verifies a user login and password or other type of login such as using encryption keys, one time passwords, etc. The profile server 122 saves information about the user logged into the system. The content server 124 comprises three levels: a persistent back-end database, middleware for logic and synchronization, and a web application server. The mobile devices 105 may be paired with the capture board 108 as will be described in more detail below. The capture board 108 may also provide synchronization and conferencing capabilities over the Internet 150 as will also be further described below.

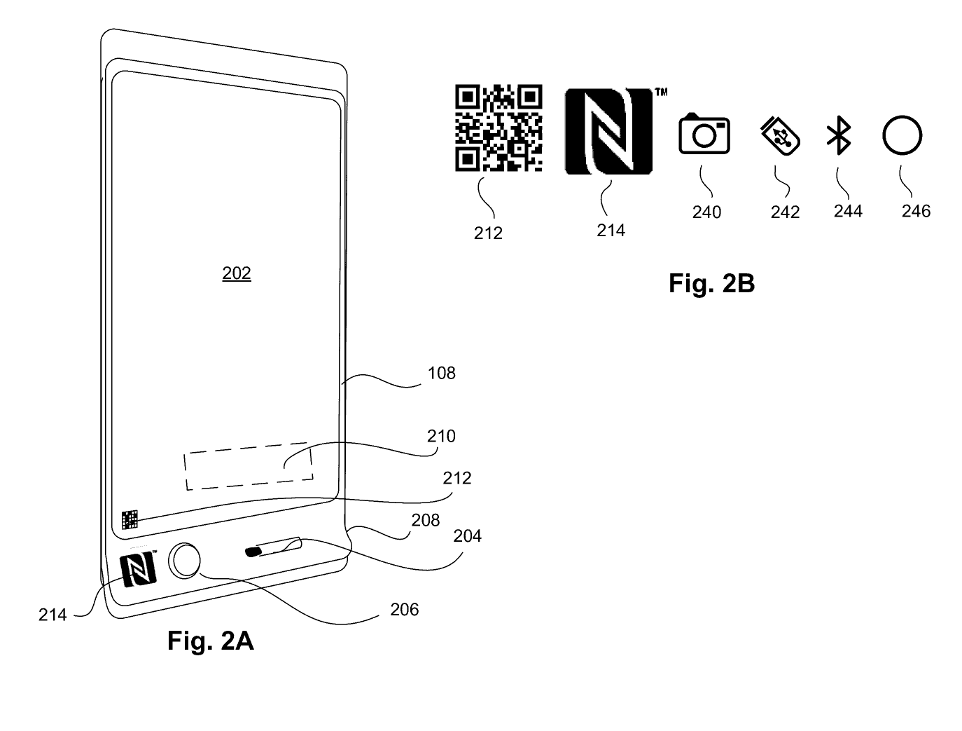

As shown in FIG. 2A, the capture board 108 comprises a generally rectangular touch area 202 whereupon a user may draw using a dry erase marker or pointer 204 and erase using an eraser 206. The capture board 108 may be in a portrait or landscape configuration and may be a variety of aspect ratios. The capture board 108 may be mounted to a vertical support surface such as for example, a wall surface or the like or optionally mounted to a moveable or stationary stand. Optionally, the touch area 202 may also have a display 318 for presenting information digitally and the marker 204 and eraser 206 produces virtual ink on the display 318. The touch area 202 comprises a touch sensing technology capable of determining and recording the pointer 204 (or eraser 206) position within the touch area 202. The recording of the path of the pointer 204 (or eraser) permits the capture board 108 to have an digital representation of all annotations stored in memory as described in more detail below.

The capture board 108 comprises at least one of a quick response (QR) code 212 and/or a near-field communication (NFC) area 214 of which may be used to pair the mobile device 105 to the capture board 108 as further described in U.S. patent Ser. No. 14/712,452, herein incorporated by reference in its entirety. The QR code 212 is a two-dimensional bar code that may be uniquely associated with the capture board 108. The NFC area 214 comprises a loop antenna (not shown) that interfaces by electromagnetic induction to a second loop antenna 340 located within the mobile device 105.

As shown in FIG. 2B, an elongate icon control bar 210 may be present adjacent the bottom of the touch area 202 or on the tool tray 208 and this icon control bar may also incorporate the QR code 212 and/or the NFC area 214. All or a portion of the control icons within the icon control bar 210 may be selectively illuminated (in one or more colours) or otherwise highlighted when activated by user interaction or system state. Alternatively, all or a portion of the icons may be completely hidden from view until placed in an active state. The icon control bar 210 may comprise a capture icon 240, a universal serial bus (USB) device connection icon 242, a Bluetooth/WiFi icon 244, and a system status icon 246 as will be further described below. Alternatively, if the capture board 108 has a display 318, then the icon control bar 210 may be digitally displayed on the display 318 and may optionally overlay the other displayed content on the display 318.

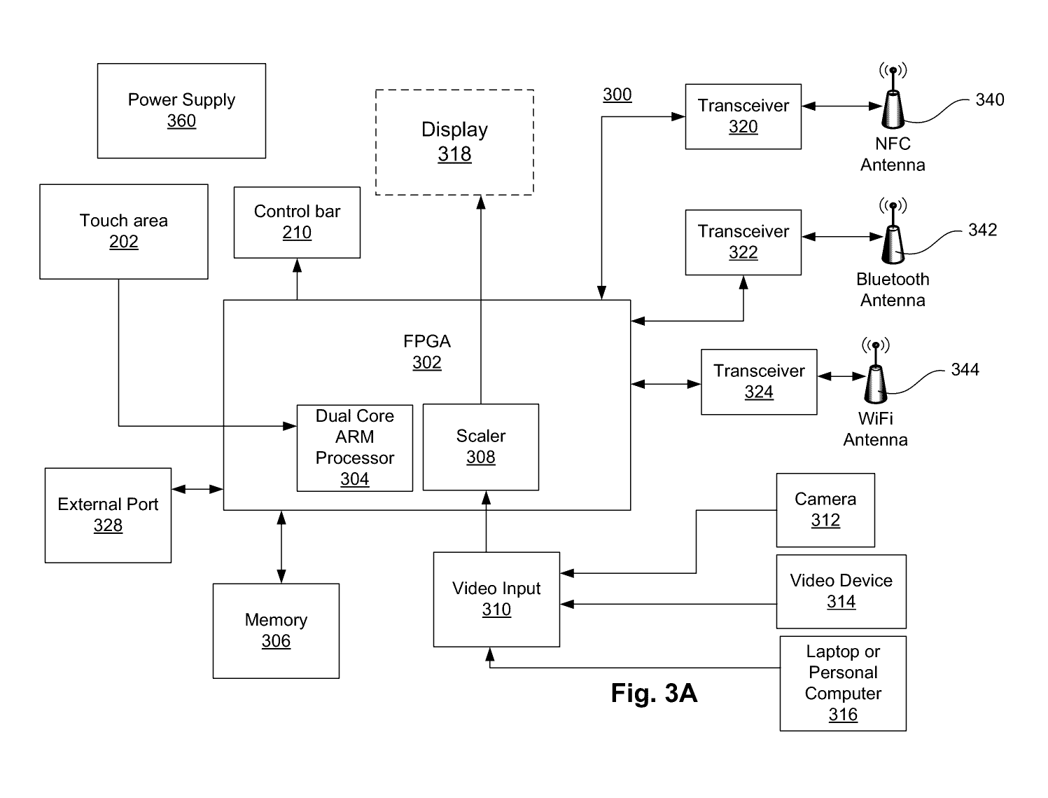

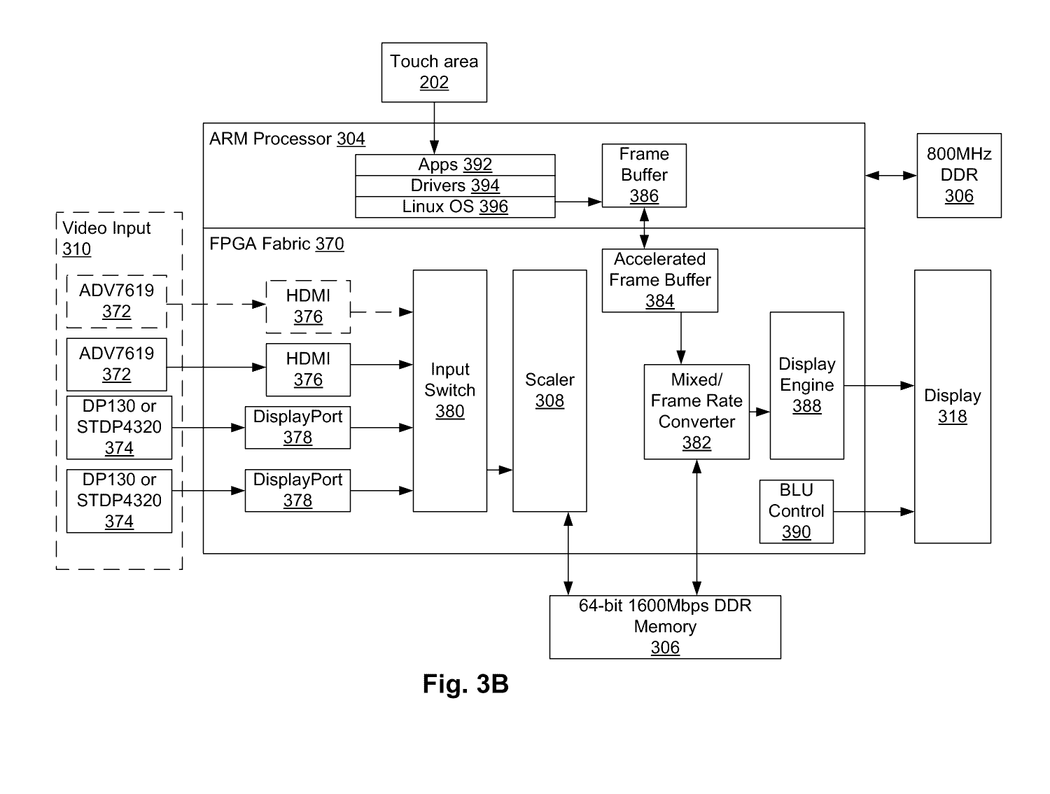

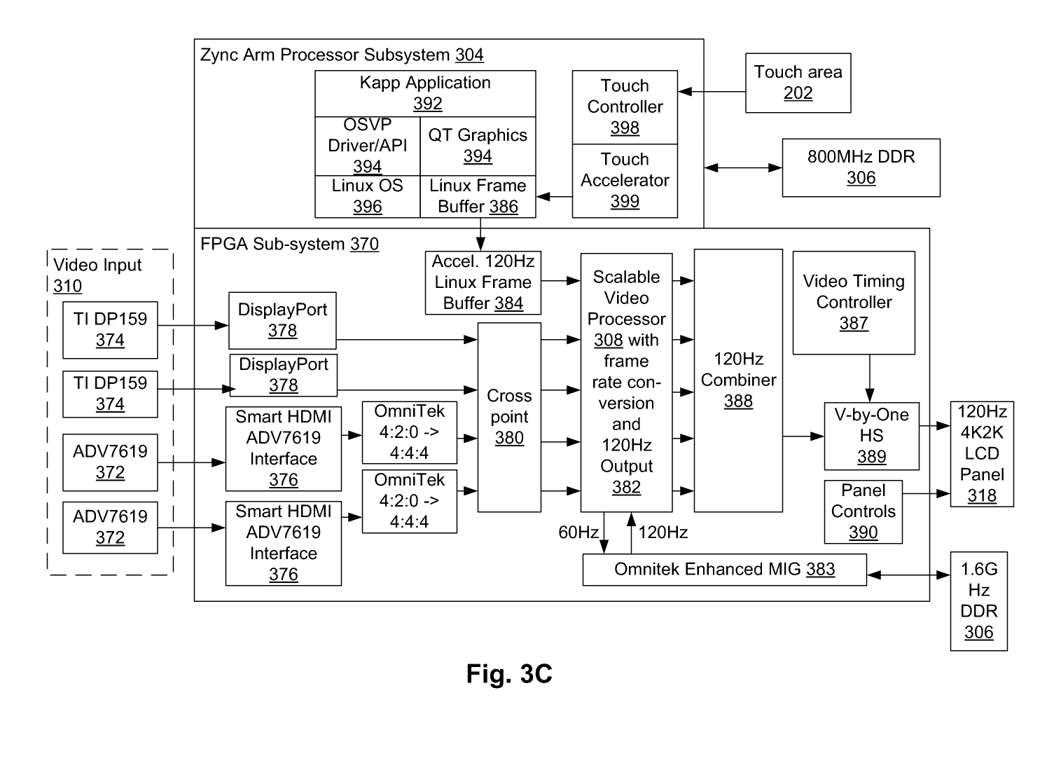

Turning to FIGS. 3A to 3C, the capture board 108 may be controlled with an field programmable gate array (FPGA) 302 or other processing structure which in this embodiment, comprises a dual core ARM Processor 304 executing instructions from volatile or non-volatile memory 306 and storing data thereto. The FPGA 302 may also comprises a scaler 308 which scales video inputs 310 to a format suitable for presenting on a display 318. The display 318 generally corresponds in approximate size and approximate shape to the touch area 202. The display 318 is typically a large-sized display for either presentation or collaboration with group of users. The resolution is sufficiently high to ensure readability of the display 318 by all participants. The video input 310 may be from a camera 312, a video device 314 such as a DVD player, Blu Ray player, VCR, etc, or a laptop or personal computer 316. The FPGA 302 communicates with the mobile device 105 (or other devices) using one or more transceivers such as, in this embodiment, an NFC transceiver 320 and antenna 340, a Bluetooth transceiver 322 and antenna 342, or a WiFi transceiver 324 and antenna 344. Optionally, the transceivers and antennas may be incorporated into a single transceiver and antenna. The FPGA 302 may also communicate with an external device 328 such as a USB memory storage device (not shown) where data may be stored thereto. A wired power supply 360 provides power to all the electronic components 300 of the capture board 108. The FPGA 302 interfaces with the previously mentioned icon control bar 210.

When the user contacts the pointer 204 with the touch area 202, the processor 304 tracks the motion of the pointer 204 and stores the pointer contacts in memory 306. Alternatively, the touch points may be stored as motion vectors or Bezier splines. The memory 306 therefore contains a digital representation of the drawn content within the touch area 202. Likewise, when the user contact the eraser 206 with the touch area 202, the processor 304 tracks the motion of the eraser 206 and removes drawn content from the digital representation of the drawn content. In this embodiment, the digital representation of the drawn content is stored in non-volatile memory 306.

When the pointer 204 contacts the touch area 202 in the location of the capture (or snapshot) icon 240, the FPGA 302 detects this contact as a control function which initiates the processor 304 to copy the currently stored digital representation of the drawn content to another location in memory 306 as a new page also known as a snapshot. The capture icon 240 may optionally flash during the saving of the digital representation of drawn content to another memory location. The FPGA 302 then initiates a snapshot message to one or more of the paired mobile device(s) 105 via the appropriately paired transceiver(s) 320, 322, and/or 324. The message contains an indication to the paired mobile device(s) 105 to capture the current image as a new page. Optionally, the message may also contain any changes that were made to the page after the last update sent to the mobile device(s) 105. The user may then continue to annotate or add content objects within the touch area 202. Optionally, once the transfer of the page to the paired mobile device 105 is complete, the page may be deleted from memory 306.

If a USB memory device (not shown) is connected to the external port 328, the FPGA 302 illuminates the USB device connection icon 242 in order to indicate to the user that the USB memory device is available to save the captured pages. When the user contacts the capture icon 240 with the pointer 204 and the USB memory device is present, the captured pages are transferred to the USB memory device as well as being transferred to any paired mobile device 105. The captured pages may be converted into another file format such as PDF, Evernote, XML, Microsoft Word®, Microsoft® Visio, Microsoft® Powerpoint, etc. and if the file has previously been saved on the USB memory device, then the pages since the last save may be appended to the previously saved file. During a save to the USB memory, the USB device connection icon 242 may flash to indicate a save is in progress.

If the user contacts the USB device connection icon 242 using the pointer 204 and the USB memory device is present, the FPGA 302 flushes any data caches to the USB memory device and disconnects the USB memory device in the conventional manner. If an error is encountered with the USB memory device, the FPGA 302 may cause the USB device connection icon 242 to flash red. Possible errors may be the USB memory device being formatted in an incompatible format, communication error, or other type of hardware failure.

When one or more mobile devices 105 begins pairing with the capture board 108, the FPGA 302 causes the Bluetooth icon 244 to flash. Following connection, the FPGA 302 causes the Bluetooth icon 244 to remain active. When the pointer 204 contacts the Bluetooth icon 244, the FPGA 302 may disconnect all the paired mobile devices 105 or may disconnect the last connected mobile device 105. Optionally for capture boards 108 with a display 318, the FPGA 302 may display an onscreen menu on the display 318 prompting the user to select which mobile device 105 (or remotely connected device) to disconnect. When the mobile device 105 is disconnecting from the capture board 108, the Bluetooth icon 244 may flash red in colour. If all mobile devices 105 are disconnected, the Bluetooth icon 244 may be solid red or may not be illuminated.

When the FPGA 302 is powered and the capture board 108 is working properly, the FPGA 302 causes the system status icon 246 to become illuminated. If the FPGA 302 determines that one of the subsystems of the capture board 108 is not operational or is reporting an error, the FPGA 302 causes the system status icon 246 to flash. When the capture board 108 is not receiving power, all of the icons in the control bar 210 are not illuminated.

FIGS. 3B and 3C demonstrate examples of structures and interfaces of the FPGA 302. As previously mentioned, the FPGA 302 has an ARM Processor 304 embedded within it. The FPGA 302 also implements an FPGA Fabric or Sub-System 370 which, in this embodiment comprises mainly video scaling and processing. The video input 310 comprises receiving either High-Definition Multimedia Interface (HDMI) or DisplayPort, developed by the Video Electronics Standards Association (VESA), via one or more Xpressview 3 GHz HDMI receivers (ADV7619) 372 produced by Analog Devices, the Data Sheet and User Guide herein incorporated by reference, or one or more DisplayPort Re-driver (DP130 or DP159) 374 produced by Texas Instruments, the Data Sheet, Application Notes, User Guides, and Selection and Solution Guides herein incorporated by reference. These HDMI receivers 372 and DisplayPort re-drivers 374 interface with the FPGA 302 using corresponding circuitry implementing Smart HDMI Interfaces 376 and DisplayPort Interfaces 378 respectively. An input switch 380 detects and automatically selects the currently active video input. The input switch or crosspoint 380 passes the video signal to the scaler 308 which resizes the video to appropriately match the resolution of the currently connected display 318. Once the video is scaled, it is stored in memory 306 where it is retrieved by the mixed/frame rate converter 382.

The ARM Processor 304 has applications or services 392 executing thereon which interface with drivers 394 and the Linux Operating System 396. The Linux Operating System 396, drivers 394, and services 392 may initialize wireless stack libraries. For example, the protocols of the Bluetooth Standard, the Adopted Bluetooth Core Specification v 4.2 Master Table of Contents & Compliance Requirements herein incorporated by reference, may be initiated such as an radio frequency communication (RFCOMM) server, configure Service Discovery Protocol (SDP) records, configure a Generic Attribute Profile (GATT) server, manage network connections, reorder packets, transmit acknowledgements, in addition to the other functions described herein. The applications 392 alter the frame buffer 386 based on annotations entered by the user within the touch area 202.

A mixed/frame rate converter 382 overlays content generated by the Frame Buffer 386 and Accelerated Frame Buffer 384. The Frame Buffer 386 receives annotations and/or content objects from the touch controller 398. The Frame Buffer 386 transfers the annotation (or content object) data to be combined with the existing data in the Accelerated Frame Buffer 384. The converted video is then passed from the frame rate converter 382 to the display engine 388 which adjusts the pixels of the display 318.

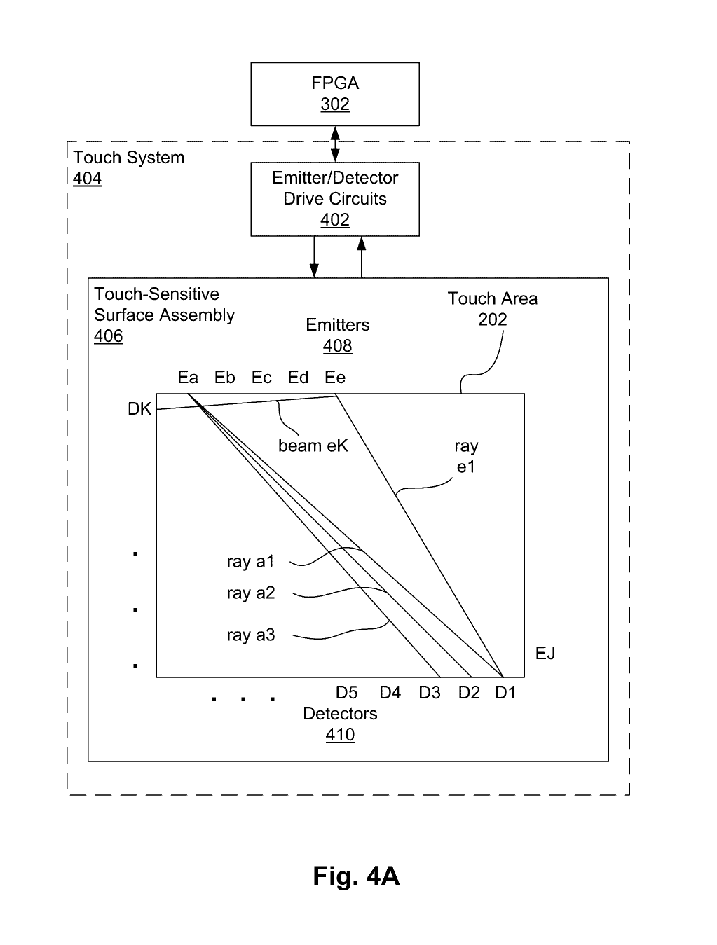

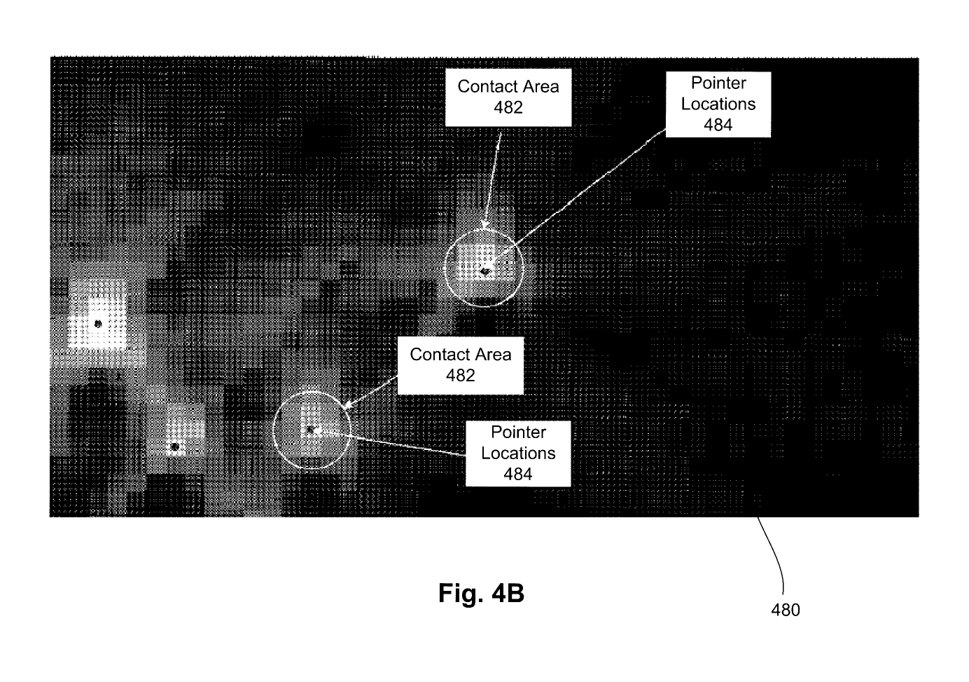

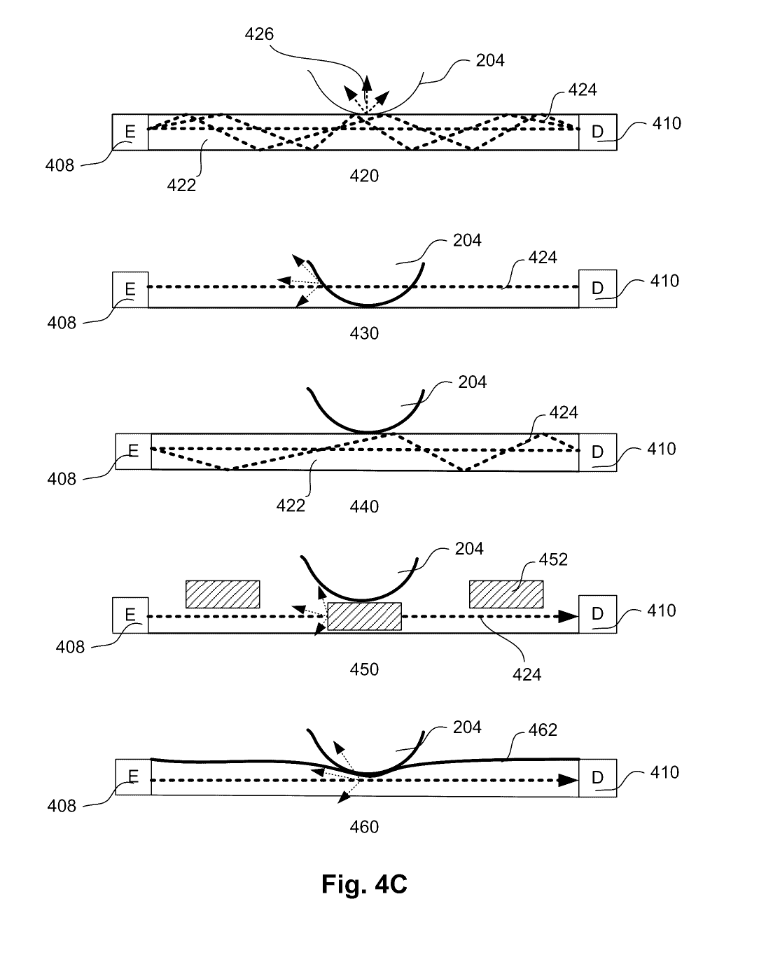

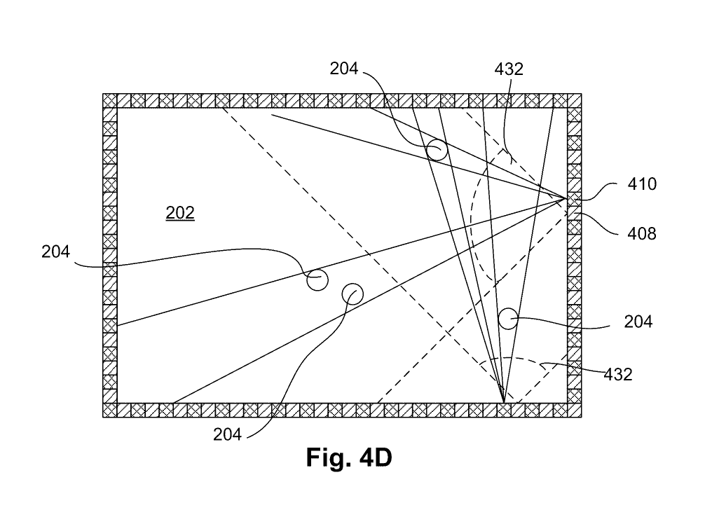

In FIG. 3C, a OmniTek Scalable Video Processing Suite, produced by OmniTek of the United Kingdom, the OSVP 2.0 Suite User Guide June 2014 herein incorporated by reference, is implemented. The scaler 308 and frame rate converter 382 are combined into a single processing block where each of the video inputs are processed independently and then combined using a 120 Hz Combiner 388. The scaler 308 may perform at least one of the following on the video: chroma upsampling, colour correction, deinterlacing, noise reduction, cropping, resizing, and/or any combination thereof. The scaled and combined video signal is then transmitted to the display 318 using a V-by-One HS interface 389 which is an electrical digital signaling standard that can run at up to 3.75 Gbit/s for each pair of conductors using a video timing controller 387. An additional feature of the embodiment shown in FIG. 3C is an enhanced Memory Interface Generator (MIG) 383 which optimizes memory bandwidth with the FPGA 302. The touch area 202 provides either transmittance coefficients to a touch controller 398 or may optionally provide raw electrical signals or images. The touch controller 398 then processes the transmittance coefficients to determine touch locations as further described below with reference to FIG. 4A to 4C. The touch accelerator 399 determines which pointer 204 is annotating or adding content objects and injects the annotations or content objects directly into the Linux Frame buffer 386 using the appropriate ink attributes.

The FPGA 302 may also contain backlight control unit (BLU) or panel control circuitry 390 which controls various aspects of the display 318 such as backlight, power switch, on-screen displays, etc.

The touch area 202 of the embodiment of the invention is observed with reference to FIGS. 4A to 4D and further disclosed in U.S. Pat. No. 8,723,840 to Rapt Touch, Inc. and Rapt IP Ltd respectively, the contents thereof incorporated by reference in their entirety. The FPGA 302 interfaces and controls the touch system 404 comprising emitter/detector drive circuits 402 and a touch-sensitive surface assembly 406. As previously mentioned, the touch area 202 is the surface on which touch events are to be detected. The surface assembly 406 includes emitters 408 and detectors 410 arranged around the periphery of the touch area 202. In this example, there are K detectors identified as D1 to DK and J emitters identified as Ea to EJ. The emitter/detector drive circuits 402 provide an interface between the FPGA 302 whereby the FPGA 302 is able to independently control and power the emitters 408 and detectors 410. The emitters 408 produce a fan of illumination generally in the infrared (IR) band whereby the light produced by one emitter 408 may be received by more than one detector 410. A “ray of light” refers to the light path from one emitter to one detector irrespective of the fan of illumination being received at other detectors. The ray from emitter Ej to detector Dk is referred to as ray jk. In the present example, rays a1, a2, a3, e1 and eK are examples.

When the pointer 204 contact the touch area 202, the fan of light produced by the emitter(s) 408 is disturbed thus changing the intensity of the ray of light received at each of the detectors 410. The FPGA 302 calculates a transmission coefficient Tjk for each ray in order to determine the location and times of contacts with the touch area 202. The transmission coefficient Tjk is the transmittance of the ray from the emitter j to the detector k in comparison to a baseline transmittance for the ray. The baseline transmittance for the ray is the transmittance measured when there is no pointer 204 interacting with the touch area 202. The baseline transmittance may be based on the average of previously recorded transmittance measurements or may be a threshold of transmittance measurements determined during a calibration phase. The inventor also contemplates that other measures may be used in place of transmittance such as absorption, attenuation, reflection, scattering, or intensity.

The FPGA 302 then processes the transmittance coefficients Tjk from a plurality of rays and determines touch regions corresponding to one or more pointers 204. Optionally, the FPGA 302 may also calculate one or more physical attributes such as contact pressure, pressure gradients, spatial pressure distributions, pointer type, pointer size, pointer shape, determination of glyph or icon or other identifiable pattern on pointer, etc.

Based on the transmittance coefficients Tjk for each of the rays, a transmittance map is generated by the FPGA 302 such as shown in FIG. 4B. The transmittance map 480 is a grayscale image whereby each pixel in the grayscale image represents a different “binding value” and in this embodiment each pixel has a width and breadth of 2.5 mm. Contact areas 482 are represented as white areas and non-contact areas are represented as dark gray or black areas. The contact areas 482 are determined using various machine vision techniques such as, for example, pattern recognition, filtering, or peak finding. The pointer locations 484 are determined using a method such as peak finding where one or more maximums is detected in the 2D transmittance map within the contact areas 482. Once the pointer locations 484 are known in the transmittance map 480, these locations 484 may be triangulated and referenced to locations on the display 318 (if present). Methods for determining these contact locations 484 are disclosed in U.S. Patent Publication No. 2014/0152624, herein incorporated by reference.

Five example configurations for the touch area 202 are presented in FIG. 4C. Configurations 420 to 440 are configurations whereby the pointer 204 interacts directly with the illumination being generated by the emitters 408. Configurations 450 and 460 are configurations whereby the pointer 204 interacts with an intermediate structure in order to influence the emitted light rays.

A frustrated total internal reflection (FTIR) configuration 420 has the emitters 408 and detectors 410 optically mated to an optically transparent waveguide 422 made of glass or plastic. The light rays 424 enter the waveguide 422 and is confined to the waveguide 422 by total internal reflection (TIR). The pointer 204 having a higher refractive index than air comes into contact with the waveguide 422. The increase in the refractive index at the contact area 482 causes the light to leak 426 from the waveguide 422. The light loss attenuates rays 424 passing through the contact area 482 resulting in less light intensity received at the detectors 410.

A beam blockage configuration 430, further shown in more detail with respect to FIG. 4D, has emitters 408 providing illumination over the touch area 202 to be received at detectors 410 receiving illumination passing over the touch area 202. The emitter(s) 408 has an illumination field 432 of approximately 90-degrees that illuminates a plurality of pointers 204. The pointer 204 enters the area above the touch area 202 whereby it partially or entirely blocks the rays 424 passing through the contact area 482. The detectors 410 similarly have an approximately 90-degree field of view and receive illumination either from the emitters 408 opposite thereto or receive reflected illumination from the pointers 204 in the case of a reflective or retro-reflective pointer 204. The emitters 408 are illuminated one at a time or a few at a time and measurements are taken at each of the receivers to generate a similar transmittance map as shown in FIG. 4B.

Another total internal reflection (TIR) configuration 440 is based on propagation angle. The ray is guided in the waveguide 422 via TIR where the ray hits the waveguide-air interface at a certain angle and is reflected back at the same angle. Pointer 204 contact with the waveguide 422 steepens the propagation angle for rays passing through the contact area 482. The detector 410 receives a response that varies as a function of the angle of propagation.

The configuration 450 show an example of using an intermediate structure 452 to block or attenuate the light passing through the contact area 482. When the pointer 204 contacts the intermediate structure 452, the intermediate structure 452 moves into the touch area 202 causing the structure 452 to partially or entirely block the rays passing through the contact area 482. In another alternative, the pointer 204 may pull the intermediate structure 452 by way of magnetic force towards the pointer 204 causing the light to be blocked.

In an alternative configuration 460, the intermediate structure 452 may be a continuous structure 462 rather than the discrete structure 452 shown for configuration 450. The intermediate structure 452 is a compressible sheet 462 that when contacted by the pointer 204 causes the sheet 462 to deform into the path of the light. Any rays 424 passing through the contact area 482 are attenuated based on the optical attributes of the sheet 462. In embodiments where a display 318 is present, the sheet 462 is transparent. Other alternative configurations for the touch system are described in U.S. patent Ser. No. 14/452,882 and U.S. patent Ser. No. 14/231,154, both of which are herein incorporated by reference in their entirety.

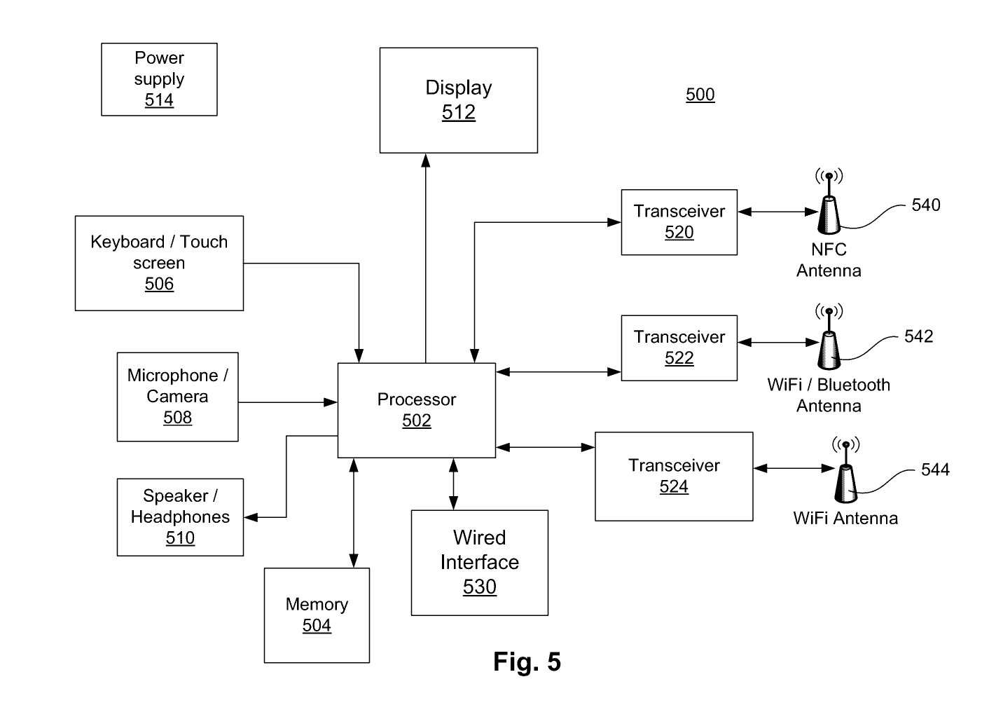

The components of an example mobile device 500 is further disclosed in FIG. 5 having a processor 502 executing instructions from volatile or non-volatile memory 504 and storing data thereto. The mobile device 500 has a number of human-computer interfaces such as a keypad or touch screen 506, a microphone and/or camera 508, a speaker or headphones 510, and a display 512, or any combinations thereof. The mobile device has a battery 514 supplying power to all the electronic components within the device. The battery 514 may be charged using wired or wireless charging.

The keyboard 506 could be a conventional keyboard found on most laptop computers or a soft-form keyboard constructed of flexible silicone material. The keyboard 506 could be a standard-sized 101-key or 104-key keyboard, a laptop-sized keyboard lacking a number pad, a handheld keyboard, a thumb-sized keyboard or a chorded keyboard known in the art. Alternatively, the mobile device 500 could have only a virtual keyboard displayed on the display 512 and uses a touch screen 506. The touch screen 506 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 506 could be a single touch or multi-touch screen. Alternatively, the microphone 508 may be used for input into the mobile device 500 using voice recognition.

The display 512 is typically small-size between the range of 1.5 inches to 14 inches to enable portability and has a resolution high enough to ensure readability of the display 512 at in-use distances. The display 512 could be a liquid crystal display (LCD) of any type, plasma, e-Ink®, projected, or any other display technology known in the art. If a touch screen 506 is present in the device, the display 512 is typically sized to be approximately the same size as the touch screen 506. The processor 502 generates a user interface for presentation on the display 512. The user controls the information displayed on the display 512 using either the touch screen or the keyboard 506 in conjunction with the user interface. Alternatively, the mobile device 500 may not have a display 512 and rely on sound through the speakers 510 or other display devices to present information.

The mobile device 500 has a number of network transceivers coupled to antennas for the processor to communicate with other devices. For example, the mobile device 500 may have a near-field communication (NFC) transceiver 520 and antenna 540; a WiFi®/Bluetooth® transceiver 522 and antenna 542; a cellular transceiver 524 and antenna 544 where at least one of the transceivers is a pairing transceiver used to pair devices. The mobile device 500 optionally also has a wired interface 530 such as USB or Ethernet connection.

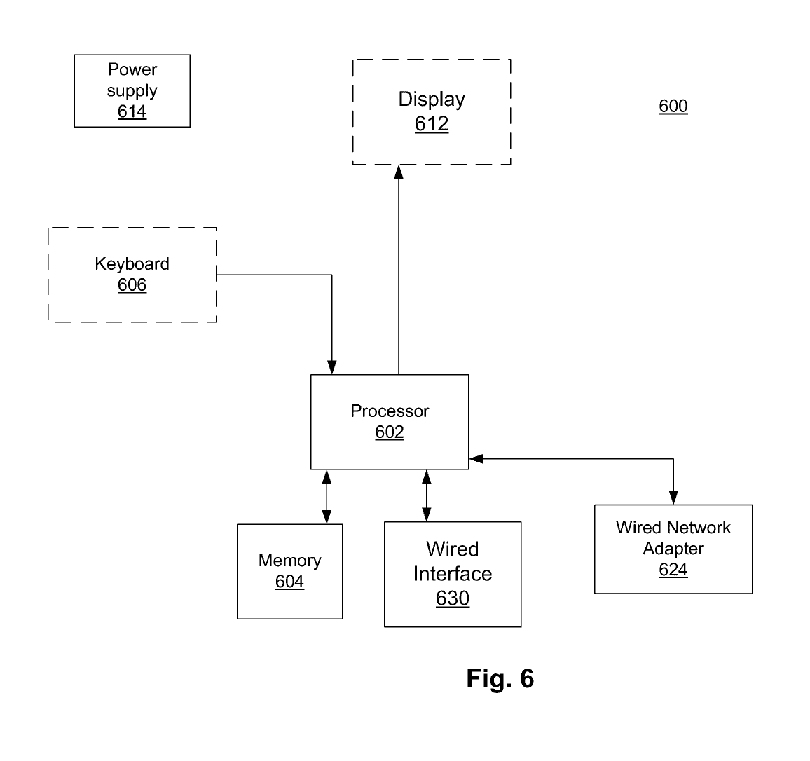

The servers 120, 122, 124 shown in FIG. 6 of the present embodiment have a similar structure to each other. The servers 120, 122, 124 have a processor 602 executing instructions from volatile or non-volatile memory 604 and storing data thereto. The servers 120, 122, 124 may or may not have a keyboard 306 and/or a display 312. The servers 120, 122, 124 communicate over the Internet 150 using the wired network adapter 624 to exchange information with the paired mobile device 105 and/or the capture board 108, conferencing, and sharing of captured content. The servers 120, 122, 124 may also have a wired interface 630 for connecting to backup storage devices or other type of peripheral known in the art. A wired power supply 614 supplies power to all of the electronic components of the servers 120, 122, 124.

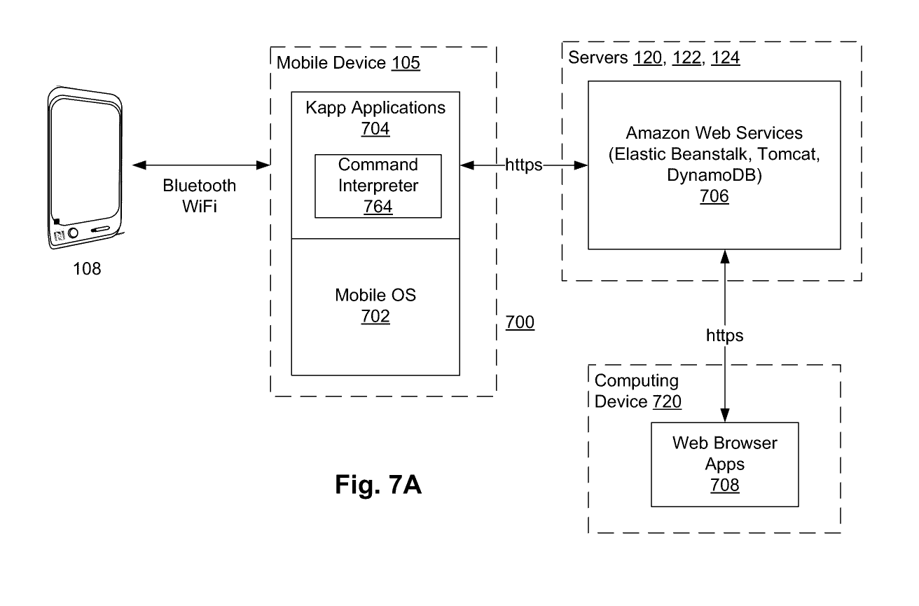

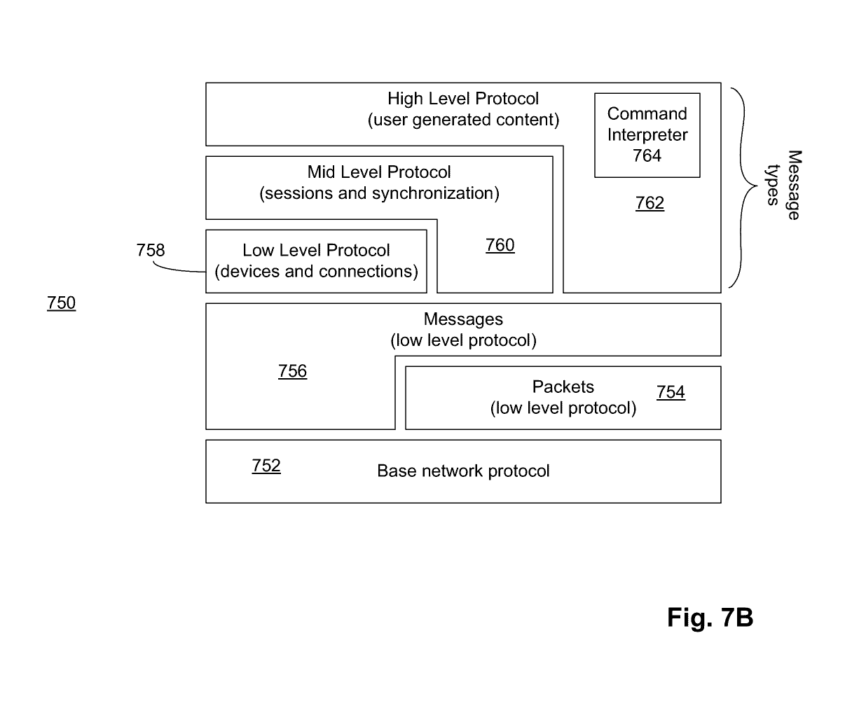

An overview of the system architecture 700 is presented in FIGS. 7A and 7B. The capture board 108 is paired with the mobile device 105 to create one or more wireless communications channels between the two devices. The mobile device 105 executes a mobile operating system (OS) 702 which generally manages the operation and hardware of the mobile device 105 and provides services for software applications 704 executing thereon. The software applications 704 communicate with the servers 120, 122, 124 executing a cloud-based execution and storage platform 706, such as for example Amazon Web Services, Elastic Beanstalk, Tomcat, DynamoDB, etc, using a secure hypertext transfer protocol (https). The software applications 704 may comprise a command interpreter 764 that modifies content objects prior to transmitting them to the servers 120, 122, 124 or other computing devices 720 participating in a collaborative session. Any content stored on the cloud-based execution and storage platform 706 may be accessed using an HTML5-capable web browser application 708, such as Chrome, Internet Explorer, Firefox, etc, executing on a computer device 720. When the mobile device 105 connects to the capture board 108 and the servers 120, 122, 124, a session is generated as further described below. Each session has a unique session identifier.

FIG. 7B shows an example protocol stack 750 used by the devices connected to the session. The base network protocol layer 752 generally corresponds to the underlying communication protocol, such as for example, Bluetooth, WiFi Direct, WiFi, USB, Wireless USB, TCP/IP, UDP/IP, etc. and may vary based by the type of device. The packets layer 754 implement secure, in-order, reliable stream-oriented full-duplex communication when the base networking protocol 752 does not provide this functionality. The packets layer 754 may be optional depending on the underlying base network protocol layer 752. The messages layer 756 in particular handles all routing and communication of messages to the other devices in the session. The low level protocol layer 758 handles redirecting devices to other connections. The mid level protocol layer 760 handles the setup and synchronization of sessions. The High Level Protocol 762 handles messages relating the user generated content as further described herein.

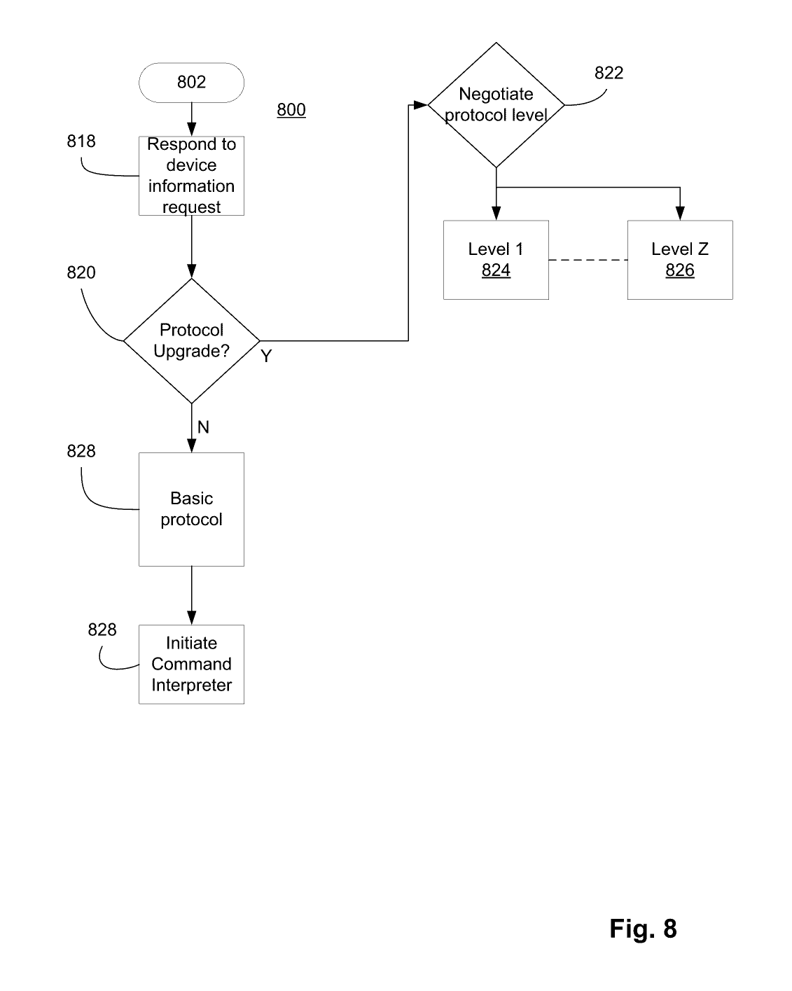

In order to accommodate different types of capture boards 108, such as for example boards with or without displays, differing hardware capabilities, etc, the communication protocol may be optimized through a protocol level negotiation as shown in FIG. 8. On connection establishment, all devices assume a basic level protocol. The dedicated application executing on the mobile device 105 transmits a device information request in order to obtain information from the capture board 108. In response, the capture board 108 indicates if it is capable of higher level protocols (step 818). The dedicated application may, at its discretion, choose to upgrade the session to the higher level protocol by transmitting a protocol upgrade request message (step 820). If the capture board 108 is unable to upgrade the session to a higher level, the capture board 108 returns a negative response and the protocol level remains at the basic level by executing a command interpreter 764 (step 828) as further described below. Any change in protocol options is assumed to take effect with the packet immediately following the affirmative response message being received from the capture board 108.

The protocol level may be specified using a “tag” with an associated “value.” For every option, there may be an implied default value that is assumed if it is not explicitly negotiated. The capture board 108 may reject any unsupported option based on the option tag by sending a negative response. If the capture board 108 is capable of supporting the value, it may respond with an affirmative response and takes effect on the next packet it sends.

If the capture board 108 may support a higher level, but not as high as the value specified by the mobile device 105, then the capture board 108 responds with an affirmative response packet having the tag and value that the capture board 108 actually supports (step 822). For example, if the mobile device 105 requests a protocol level of “5” and the capture board 108 only supports a level of “2”, then the capture board 108 responds indicating it only supports a level of “2”. The mobile device 105 then set its protocol level to “2”. There may be a number of different protocol levels from Level 1 (step 824) to Level Z (step 826). Once the protocol level has been selected, the dedicated application and the capture board 108 adjust and optimize their operation for that protocol level.

In the present embodiment, two protocol levels are available and are referred to as the basic protocol and Level 1 protocol accordingly. The basic protocol may be used with a capture board 108 having no display 318 or communication capabilities to the Internet 150. In some embodiments, this basic type of capture board 108 may only communicate with a single mobile device 105. Sessions using the basic protocol may have only one capture board 108. The Level 1 protocol may be used with one or more capture boards 108 that have a display 318 and/or communication capabilities to the Internet 150.

With the basic protocol, the capture board 108 may transmit user-generated content that originates only by user interaction on the touch area 202. As a result, the basic protocol does not require a sophisticated method of differentiation of the source of annotations. In the case where the capture board 108 is multi-write capable, the only differentiation required may be a simple 8-bit contact number field that could be uniquely and solely determined by the capture board 108.

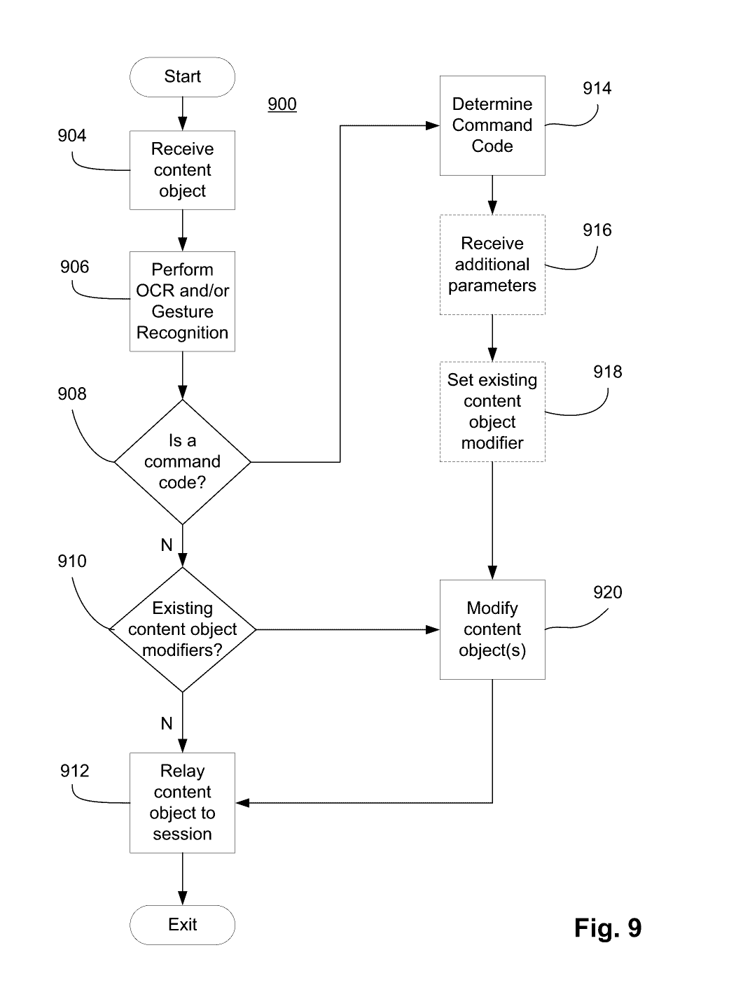

When a basic level capture board 108 attempts to connect to the two-way user content session, the mobile device 105 generates a unique ID for the basic level capture board 108 and acts as a proxy server that translates the basic level communications from the capture board 108 into a Level 1 or higher communication protocol. The mobile device 105 initiates the command interpreter 764 at step 828, which causes one or more content objects to be processed by the command interpreter, as further described with reference to FIG. 9, prior to being transmitted to the session.

When the command interpreter 764 is active, the process 900 is executed by the mobile device 105. The command interpreter 764 receives content objects from the capture board 108 (step 904) and performs optical character recognition (OCR) and/or shape recognition as is known in the art upon the content object (step 906). The recognized content object is then parsed to determine if a command code exists therein (step 908). Command codes may be indicated by an uncommon character combination or other form of tag such as, for example, leading the command code with a “#” or enclosing the command code in a set of brackets such as “<” and “>”. Additional information may be included with the command code by appending an equal sign “=”. If a command code is not identified, the content object is checked against a list of existing content object modifiers that may apply to the content object (step 910). If no existing content object modifiers apply to the content object, the content object is relayed to the session without modification.

If the command code has been identified in step 908, the command code is checked against a list of known command codes (step 914) in order to determine how the content object is to be modified. Optionally, if the command code cannot be determined, an error may be displayed on the mobile device 105. Once the command code is determined, additional parameters may be received from the capture board 108 or parsed from the content object. One such parameter may be the location of the content object to be modified. The command code and parameters may then be set in an existing content object modifier list (step 918). The content object is then modified according to the applicable command code and parameters (step 920). Equally, after step 910, this modification step 920 is also performed. The modified content object is then relayed to the session (step 912).

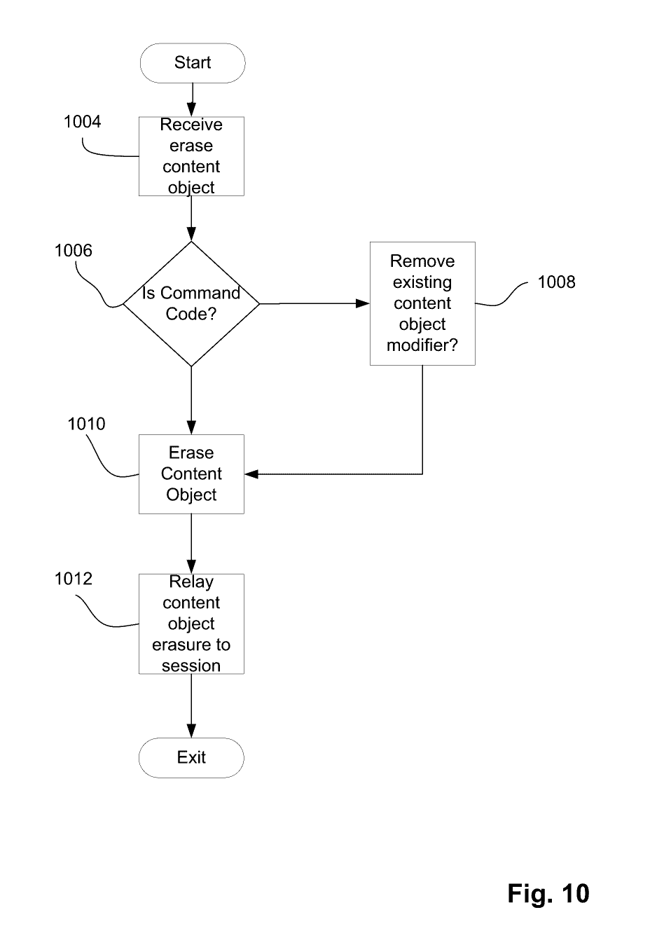

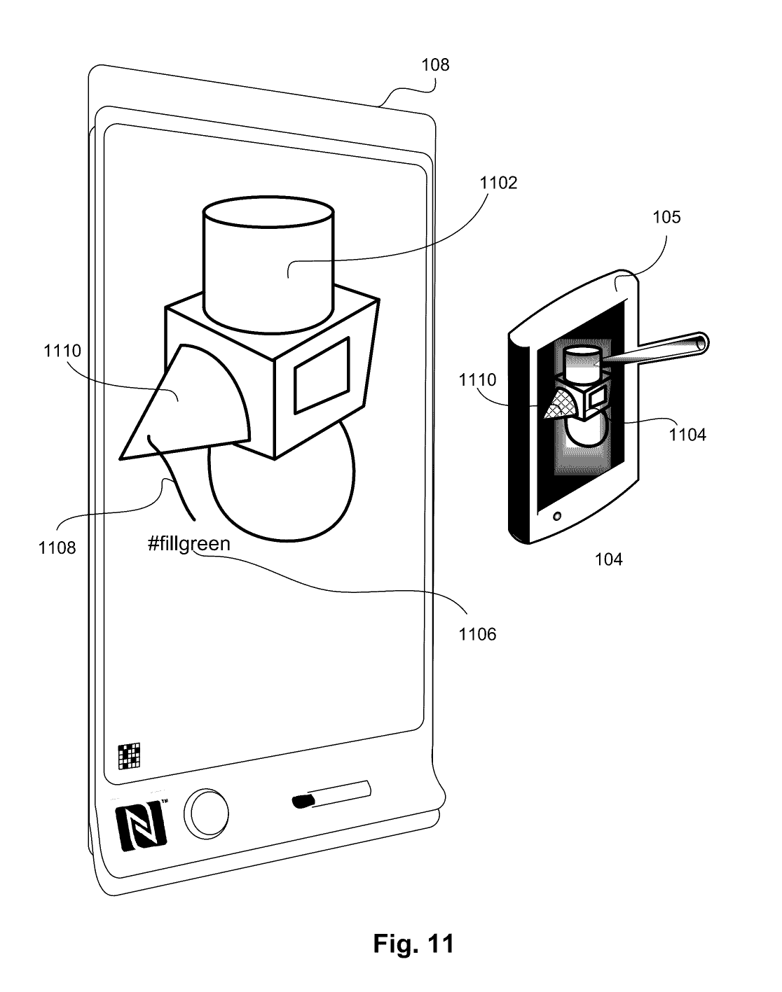

Turning now to FIG. 10, an erasure of a content object is received from the capture board 108 (step 1004). The erased content object is determined if it is a command code (step 1006). If the command code is erased, then the command code is removed from the content object modifier list (step 1008). In any event, the content object is erased from the mobile device 105 (step 1010) and the erasure is relayed to the session (step 1012).

Example command codes are now described below and are intended to be only examples. The inventor contemplates that other command codes may be possible.

One example of a command code may be used to modify digital ink attributes by writing an ink attribute command codes on the touch surface such as “<blue>” or “#blue”. The content interpreter would identify the command code (step 914) and add it to the content object modifier list (step 918). All content objects created on the capture board 108 following this command may then be rendered in blue, even though the basic level capture board 108 is only capable of a binary black and white representation. Other examples of digital ink attribute command codes may be “<highlight>”, “<bold>”, “#linewidth=XX” where “XX” is the line width in pixels, “#fontsize=YY” where “YY” is the font size in points, etc. When the user desires a different pointer attribute, the user erases the pointer attribute command code (step 1004) which signals to the mobile device 105 that the command code is to be removed from the existing content object modifier list (step 1008).

In another example shown in FIG. 11, a complex content object 1102 was previously drawn by the user on the capture board 108. The representation of the complex content object 1104 was previously transferred as one or more content objects to the mobile device 105 (enlarged in order to show detail) and displayed on the screen 512. The user writes the fill command code such as “#fillgreen” 1106 on the capture board 108 followed by an arrow or line 1108 to an enclosed portion 1110 of the content object 1102. The command interpreter 764 executing on the mobile device 105 receives the fill command code and the arrow parameter 1108 indicating the specific content object (or content objects) 1102 and/or an indication of the enclosed portion 1110. The dedicated application executing on the mobile device 105 then fills the enclosed portion 1110 (shown as a hashed area) in the representation of the complex content object 1104 and transmits this change to the session.

Another example of a command code may permit the capture board 108 to grow the canvas size with a “#canvasgrow” command code. For a basic level capture board 108, the canvas typically has a 1:1 ratio with respect to the size of the touch area. Once the command interpreter 764 receives the canvas size command code, the canvas may grow in predefined increments (e.g. medium, medium-large, large, extra large, jumbo) or the user may specify a particular canvas size (e.g. diagonal length, width and/or height, or percentage increase) in pixels or some other form of measurement such as inches, centimeters, etc. In response, the command interpreter 764 may, instead of modifying the content object (step 920), instruct the dedicated application to issue a protocol upgrade message to adjust the canvas size used in the session. The processor 502 of the mobile device 105 may scale the view of the canvas larger or smaller.

In yet another example, the command interpreter 764 may also identify a basic move (or translate) command code such as “#move”. Once the command interpreter 764 identifies the move command code, the next content object circled on the capture board 108 is identified as an additional parameter (step 916) indicating the object to be moved. The user then draws a line as an additional parameter (step 916) indicating the relative motion to the command interpreter 764 which causes the dedicated application to move the object according to the relative motion. Alternatively, the additional parameter may be a cardinal direction and/or a number of pixels. This type of command code would not be persistent and thus would not be added to the existing content object modifier (step 918). As the basic level capture board 108 is typically relies on dry erase marker for feedback to the user, the number of movements of objects is limited and may typically be used following a “#canvasgrow” command code.

Another example of a command code may be a rotate command code such as “#objectrotate”. Once the command interpreter 764 identifies the rotate command code (step 914), the content object circled on the capture board 108 is identified as an additional parameter (step 916) indicating the content object to be rotated. The user then draws an arc as another parameter indicating the direction of rotation. Alternatively, the additional parameter may be a written direction (e.g. clockwise or counterclockwise) and/or a number of degrees such as “#clockwise=30”. The command interpreter 764 then rotates the content object by the specified angle (step 920). Similar to the move command code, the rotate command code is not persistent and thus would not be added to the existing content object modifier (step 918).

In addition to scaling the canvas, another example of a command code may scale the content object using the command code such as “#objectscale”. Once the command interpreter 764 identifies the object scale command code (step 914), the next content object circled on the capture board 108 is identified as the object to be scaled (step 916). The user then draws a vertical line indicated the relative scaling to the command interpreter 764 (step 916) which causes the dedicated application to scale the object according to the relative motion where upward motion causes the content object to grow in size and downward motion causes the content object to shrink in size. Alternatively, the additional parameter may be either a “#reduce” or “#enlarge” command code and/or a percentage. Similar to the move and rotate command codes, the scaling command code would not be added to the existing content object modifier (step 918).

In another example, the command interpreter 764 may identify a group and ungroup command code such as “#group” and/or “#ungroup”. Once the command interpreter 764 identifies the group command code (step 914), the content objects circled on the capture board 108 are identified as the objects to be grouped (step 916). The dedicated application then groups these content objects together and notifies the session. The ungroup command code would operate in a similar manner.

In yet another example, the command interpreter 764 may also identify a mode command code such as “#mode” in order to change the current mode (step 914), which alters the dedicated application on the mobile device 105 into a different mode. For example, the command interpreter 764 may receive the mode command “#mode=conceptmap”, which causes the dedicated application to convert into a concept mapping interface and/or initialize a customized recognition engine such as that of SMART Ideas by SMART Technologies, ULC., assignee of the present invention, the User Guide herein incorporated by reference in its entirety. Following this mode change, any content object connected by a line to another content object would be converted to an appropriate shape with a connector by shape recognition. Subsequent movement of the content object on the mobile device 105 or capture board 108 would also move the connector.

In another example, the command interpreter 764 may identify command codes that alter the type of pointer 204 interactions with the capture board 108 to generate content objects that are available based, at least in part, on the capabilities of the mobile device 105. The command interpreter 764 may identify command codes (step 914) that permit the basic capture board 108 to generate annotations, alphanumeric text, images, video, active content, shapes, etc. For example, when the command code “Mine” is received by the command interpreter, any annotations on the capture board 108 are automatically straightened into line segments (step 920). Alternatively, the command code “#curve” automatically generates curve segments rather than hand drawn curves. The inventor contemplates that other command codes such as “#circle”, “#ellipse”, “#square”, “#rectangle”, “#triangle”, etc. may be interpreted.

Alternatively, a shape identification mode may be entered by entering the command code “#shape” whereby all annotation is passed through a shape recognition engine in order to determine the shape. For specific types of shapes, such as for example a circle, the shape related message (such as, for example, LINE_PATH, CURVE_PATH, CIRCLE_SHAPE, ELLIPSE_SHAPE, etc.) may be abbreviated as the (x,y) coordinates of the center of the circle and the radius. The inventor contemplates that other shapes may be represented using conic mathematical descriptions, cubic Bezier splines (or other type of spline), integrals (e.g. for filling in shapes), line segments, polygons, ellipses, etc. and may be associated with their own command codes. Alternatively the shapes may be represented by xml descriptions of scalable vector graphics (SVG). This path-related message is transmitted from the mobile device 105 to the session (step 912).

For command codes such as “#image”, “#video”, and/or “#webpage”, the command code may be followed by the user drawing a rectangle on the capture board 108 that is registered as a parameter (step 916). The user may then enter a uniform resource locator (URL) as an additional parameter (step 916) within the rectangle or otherwise pointing to the location of the respective image, video, or webpage. The mobile device 105 would then retrieve the webpage and distribute it to the session. Alternatively, the mobile device 105 would distribute the URL to the session and each device in the session would independently retrieve the URL using their connection to the Internet 150.

In yet another example, the command interpreter 764 may also identify the command code for permitting the basic capture board 108 to increase the access level. For example, a set of access levels may be present and access using the command codes such as “#observer”, “#participant”, “#contributor”, “#presenter”, and/or “#organizer”. The access levels have different rights associated with them. Observers can read all content but have no right to presence or identity (e.g. the observer device is anonymous). Participant devices may also read all content but the participant device also has the right to declare their presence and identity which implies participation in some activities within the conversation such as chat, polling, etc. by way of proxy but cannot directly contribute new user generated content. Contributor devices have general read/write access but cannot alter the access level of any other session device or terminate the session. Presenter devices have read/write access and can raise any participant to a contributor device and demote any contributor device to a participant device. Presenter devices cannot alter the access of other presenter or organizer devices and cannot terminate the session. Organizer devices have full read/write access to all aspects of the session, including altering other device access and terminating the conversation. Since the capture board 108 has no display, the display 512 of the mobile device 105 would display any remote content.

Following a command code to change access level, a password command code such as “#password=” would be necessary to increase the access level of the capture board 108.

In another example, the command interpreter 764 may identify a polling command code such as “#polling”. Once the command interpreter identifies the poll command code (step 914), the additional parameters may then correspond to the poll options and may be identified using a numbered command code such as “#option1=” to “#optionN=” followed by their respective option text (step 916). The mobile device 105 may then transmit the poll to the session participants for voting and tabulation of the results.

In a further example, the command interpreter 764 may identify an autosave command code such as “#autosave”. This command code causes the mobile device 105 to instruct the capture board 108 to take a snapshot at a predefined interval such as every 5 minutes (or other user defined or predetermined amount) that may optionally be specified by a an additional parameter or may be static.

Another example may permit the user to assign handle command codes to other users who may join the session. Entering a handle command code, which may be private such as “#Batman” or public such as the person's initials “#BTW”, whereby the handle was previously associated with the email address “bruce@wayneent.com”, would cause a notice to be sent directly to that particular email address inviting that user to the session. When the command code is erased, the user is automatically removed from the session.

Although the examples described herein have predefined command codes, the inventor contemplates that the user may teach the command interpreter 764 additional command codes based on the user's preferences. These preferences may be stored on the mobile device 105 or on the content server 124.

Although the examples described herein demonstrate that the command interpreter 764 processes all annotations, the inventor contemplates that the command interpreter 764 may only process within a specific portion of the touch area 202.

Although the examples described herein demonstrate that the command interpreter 764 maintains a specific mode until the command code is erased, the inventor contemplates that the command interpreter 764 may maintain the mode until another overriding command code is entered on the touch area 202 and this portion may be predefined or defined by the user.

Although the examples described herein are specific to annotation, the inventor contemplates that other command codes may be used such as identifying an email address.

Alternatively, the mobile device 105 may present a set of commands on its display 512 that alters how the content objects are rendered by the mobile device 105 and/or how the content objects are reported to the session.

Although the examples described herein describe selecting content objects by circling, the inventor contemplates that other selection modes may be used such as tapping within the content object, encircling the content object in another type of shape, etc.

Although the examples described herein describe the command code modifying objects following entry of the command code, the inventor contemplates that the command code may modify a previously entered content object by circling it or selecting it in some other manner. Alternatively, the command code may only modify the immediately preceding content object. Alternatively, the command code may comprise an additional parameter whereby the user draws an arrow or line to the content object to be modified by the command code. In yet another alternative example, an arrow drawn between two or more content objects may link the objects with a connector that moves when the content objects are moved.

In another alternative example, the command code, such as “#chemistry”, enables a chemical structure object recognition engine that converts any drawn chemicals into a recognized chemical structure.

Although a Bluetooth connection is described herein, the inventor contemplates that other communication systems and standards may be used such as for example, IPv4/IPv6, Wi-Fi Direct, USB (in particular, HID), Apple's iAP, RS-232 serial, etc. In those systems, another uniquely identifiable address may be used to generate a board ID using a similar manner as described herein.

Although the embodiments described herein refer to a pen, the inventor contemplates that the pointer may be any type of pointing device such as a dry erase marker, ballpoint pen, ruler, pencil, finger, thumb, or any other generally elongate member. Preferably, these pen-type devices have one or more ends configured of a material as to not damage the display 318 or touch area 202 when coming into contact therewith under in-use forces.

In an alternative embodiment, the control bar 210 may comprise an email icon. If one or more email addresses has been provided to the application executing on the mobile device 105, the FPGA 302 illuminates the email icon. When the pointer 204 contacts the email icon, the FPGA 302 pushes pending annotations to the mobile device 105 and reports to the processor of the mobile device 105 that the pages from the current notebook are to be transmitted to the email addresses. The processor then proceeds to transmit either a PDF file or a link to a location to a server on the Internet to the PDF file. If no designated email address is stored by the mobile device 105 and the pointer 204 contacts the email icon, a prompt to the user may be displayed on the display 318 whereby the user may enter email addresses through text recognition of writing events input via pointer 204. In this embodiment, input of the character “@” may prompt the FPGA 302 to recognize input writing events as a designated email address. The input writing following the “@” symbol may be verified to be a domain such as “live.com” in order to further differentiate between users entering an “@” symbol for other purposes (such as Twitter handles).

The emitters and detectors may be narrower or wider, narrower angle or wider angle, various wavelengths, various powers, coherent or not, etc. As another example, different types of multiplexing may be used to allow light from multiple emitters to be received by each detector. In another alternative, the FPGA 302 may modulate the light emitted by the emitters to enable multiple emitters to be active at once.

Although the examples described herein select the content object by circling or drawing a line connecting the command code to the content objection, the inventor contemplates that other selection modes may be used such as tapping, underlining, etc.

The touch screen 306 can be any type of touch technology such as analog resistive, capacitive, projected capacitive, ultrasonic, infrared grid, camera-based (across touch surface, at the touch surface, away from the display, etc), in-cell optical, in-cell capacitive, in-cell resistive, electromagnetic, time-of-flight, frustrated total internal reflection (FTIR), diffused surface illumination, surface acoustic wave, bending wave touch, acoustic pulse recognition, force-sensing touch technology, or any other touch technology known in the art. The touch screen 306 could be a single touch, a multi-touch screen, or a multi-user, multi-touch screen.

Although the mobile device 200 is described as a smartphone 102, tablet 104, or laptop 106, in alternative embodiments, the mobile device 105 may be built into a conventional pen, a card-like device similar to an RFID card, a camera, or other portable device.

Although the servers 120, 122, 124 are described herein as discrete servers, other combinations may be possible. For example, the three servers may be incorporated into a single server, or there may be a plurality of each type of server in order to balance the server load.

Although the examples herein have the command interpreter 764 executing on the mobile device 105, the inventor contemplates that the command interpreter 764 may be executed on one of the servers 120, 122, 124.

Although some of the examples described herein state that instructions are executing on the mobile device 105, the capture board 108, and/or the servers 120, 122, 124; this is merely a matter of convenience. The instructions are in fact executing the processor or processing structures associated with the respective device.

In another alternative example, the command interpreter 764 may identify an undo command code such as “#undo” which reverses the previous command code. Alternatively, an additional parameter may specify the number of previous command codes to reverse.

These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; 7,274,356; and 7,532,206 assigned to SMART Technologies ULC of Calgary, Alberta, Canada, assignee of the subject application, the entire disclosures of which are incorporated by reference; touch systems comprising touch panels or tables employing electromagnetic, capacitive, acoustic or other technologies to register pointer input; laptop and tablet personal computers (PCs); smartphones, personal digital assistants (PDAs) and other handheld devices; and other similar devices.

Although the examples described herein are in reference to a capture board 108, the inventor contemplates that the features and concepts may apply equally well to other collaborative devices 107 such as the interactive flat screen display 110, interactive whiteboard 112, the interactive table 114, or other type of interactive device. Each type of collaborative device 107 may have the same protocol level or different protocol levels.

The above-described embodiments are intended to be examples of the present invention and alterations and modifications may be effected thereto, by those of skill in the art, without departing from the scope of the invention, which is defined solely by the claims appended hereto.

What is claimed is:

1. A mobile device comprising:
a processing structure;
a transceiver communicating with a network using a communication protocol; and
a computer-readable medium comprising instructions to configure the processing structure to:
receive a content object from an interactive device;
perform recognition on the content object;
determine a command code from the recognized content object; and
modify another content object based at least in part on the command code.

2. The mobile device according to claim 1 further comprising instructions to configure the processing structure to: receive at least one command code parameter; and modify the another content object based in part on the at least one command code parameter.

3. The mobile device according to claim 1 further comprising instructions to configure the processing structure to: add the command code to a content object modifier list.

4. The mobile device according to claim 3 further comprising instructions to configure the processing structure to: modify at least a portion of a plurality of content objects based on the content object modifier list.

5. The mobile device according to claim 3 further comprising instructions to configure the processing structure to: identify erasure of the content object associated with the command code; and remove the erased command code from the content object modifier list.

6. The mobile device according to claim 1 wherein the command code comprises adjusting at least one content object attribute.

7. The mobile device according to claim 2 wherein the at least one content object attribute comprises a colour.

8. The mobile device according to claim 1 wherein the command code comprises a manipulation command code selected from at least one of scaling, rotation, and translation.

9. The mobile device according to claim 8 further comprising instructions to configure the processing structure to: select the another content object following the command code to be manipulated.

10. The mobile device according to claim 9 wherein a relative gesture specifies a manipulation quantity.

11. The mobile device according to claim 9 wherein the selected content object is selected by at least one of circling, tapping, underlining, and connecting to the command code.

12. The mobile device according to claim 1 wherein the command code comprises adjusting a canvas size.

13. The mobile device according to claim 1 further comprising instructions to configure the processing structure to: initialize a recognition engine in response to the command code.

14. The mobile device according to claim 13 wherein the recognition engine is selected from at least one of a shape recognition engine, a concept mapping engine, a chemical structure recognition engine, and a handwriting recognition engine.

15. The mobile device according to claim 2 wherein the command code parameter comprises a uniform resource locator to a remote content object.

16. The mobile device according to claim 1 wherein the interactive device comprises at least one of a capture board, an interactive whiteboard, an interactive flat screen display, or an interactive table.

17. A computer-implemented method comprising:
receiving, at a mobile device, a content object from an interactive device over a communication channel;
performing recognition on the content object;
determining a command code from the recognized content object; and
modifying another content object based at least in part on the command code.

18. The computer-implemented method according to claim 17 further comprising receiving at least one command code parameter from the interactive device; and modifying the another content object based in part on the at least one command code parameter.

19. The computer-implemented method according to claim 17 further comprising adding the command code to a content object modifier list.

20. The computer-implemented method to claim 19 further comprising modifying at least a portion of a plurality of content objects based on the command codes on the content object modifier list.

21. The computer-implemented method according to claim 19 further comprising identifying erasure of the command code; and removing the erased command code from the content object modifier list.

22. The computer-implemented method according to claim 17 wherein the command code comprises adjusting at least one content object attribute.

23. The computer-implemented method according to claim 20 wherein the at least one content object attribute comprises a colour.

24. The computer-implemented method according to claim 17 wherein the command code comprises a manipulation command code selected from at least one of scaling, rotation, and translation.

25. The computer-implemented method according to claim 24 further comprising selecting the another content object following the command code to be manipulated.

26. The computer-implemented method according to claim 25 wherein a relative gesture specifies a manipulation quantity.

27. The computer-implemented method according to claim 25 wherein the selected content object is selected by at least one of circling, tapping, underlining, and connecting to the command code.

28. The computer-implemented method according to claim 17 wherein the command code comprises adjusting a canvas size.

29. The computer-implemented method according to claim 17 further comprising initializing a recognition engine in response to the command code.

30. The computer-implemented method according to claim 29 wherein the recognition engine is selected from at least one of a shape recognition engine, a concept mapping engine, a chemical structure recognition engine, and a handwriting recognition engine.

31. The computer-implemented method according to claim 20 wherein the command code parameter comprises a uniform resource locator to a remote content object.

32. The computer-implemented method according to claim 17 wherein the interactive device comprises at least one of a capture board, an interactive whiteboard, an interactive flat screen display, or an interactive table.

33. An interactive device comprising:
a processing structure;
an interactive surface;
a transceiver communicating with a network using a communication protocol; and
a computer-readable medium comprising instructions to configure the processing structure to:
provide a command code to a mobile device; and
provide command code parameters to the mobile device.
